(19) United States
(12) Patent Application Publication
(10) Pub. No.: US 2008/0024052 A1
(43) Pub. Date: Jan. 31, 2008

(54) Display device

(75) Inventors: Hideyuki Shintani, Mobara (JP); Tsutomu Kuniyasu, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/826,637

(22) Filed: Jul. 17, 2007

(30) Foreign Application Priority Data
Jul. 31, 2006 (JP) 2006-207369

(51) Int. Cl. H01J 1/62

(52) U.S. Cl. 313/496

(57) ABSTRACT

An electron emission display having a rear board and a front board is apt to cause electric discharge between scanning lines formed on the rear board and an anode formed on the front board. In the electron emission display, the rear board and the front board are each constituted by a flat board and are disposed so that the respective plane surfaces are opposed to each other. Scanning lines and data lines are formed on the plane surface of the rear board. The scanning lines each have an upper surface opposed to the front board and connecting surfaces adjacent to the upper surface and inclined at an angle of 15° to 75° relative to the upper surface. Since the scanning lines are each provided with such inclined connecting surfaces, it is possible to suppress electric discharge between the anode and the scanning lines.

### CLAIM OF PRIORITY

The present application claims priority from Japanese Application JP 2006-207369 filed on Jul. 31, 2006, the content of which is hereby incorporated by reference into this application.

### BACKGROUND OF THE INVENTION

1. Field of the Invention

The present invention relates to a display device and more particularly to a display device having a vacuum housing composed of a rear board, a front board and a frame.

2. Description of the Prior Art

A display device which displays an image by impinging electrons on a fluorescent screen includes an electron emission display which uses a cold cathode from which electrons are emitted to display an image, in addition to a cathode-ray tube using a hot cathode.

A housing (or a vessel) of the electron emission display is composed of a rear board having a plurality of electron emitting elements, a front board having a fluorescent screen, and a panel frame which connects the rear board with the front board. Both scanning lines and data lines are formed on the rear board, and electrodes of an electron source are connected to those lines. On the other hand, a fluorescent screen is formed on the front board disposed in opposition to the rear board, the fluorescent screen having a black matrix, a phosphor layer and an anode.

The interior of the housing is held at a high degree of vacuum in order to facilitate movement of electrons emitted from the electron emitting elements. In such a display device, the electrons emitted from the electron emitting elements impinge on the fluorescent screen disposed in opposition to the electron emitting elements, whereby the fluorescent screen emits light and an image is displayed. The housing is designed so as to withstand the atmospheric pressure. In the case of a display device having a large screen size, however, there is the possibility that a front board or a rear board may be depressed inwards of the housing. To prevent such a depression of the front or rear board, a spacer is disposed within an image display area.

A field emission type electron source, a surface conduction type electron source, or a thin film type electron source is used as an electron source of the electron emission display, for example. CNT (carbon nanotube) and a Spindt type electron source are known As examples of the field emission type electron source. MIM (metal layer/insulator layer/metal layer), MIS (metal layer/insulator layer/semiconductor layer), and MISM (metal layer/insulator layer/semiconductor layer/metal layer) are known as examples of the thin film type electron source.

The electron emission display can be reduced in thickness and is now attracting attention of many concerns as a thin display device having the image quality of the cathode-ray tube. However, as the thickness thereof is reduced, electric discharge between the rear board and the front board may occur.

JP-A-2002-169504 discloses that an electron emitting section shut-off circuit is disposed between an electron emitting section and an electron emitting section drive circuit.

JP-A-2003-217468 discloses a display device having an earth electrode in an invalid area which surrounds an effective area functioning as a display section.

In the electron emission display, the spacing between the front and rear boards is suitably selected in the range of about 3 to 5 mm. Voltage of 5 to 10 kV is applied to the anode, whereby the electrons emitted from the electron source is conducted to the fluorescent screen. In the electron emission display, since voltage of several kilovolts is applied between the rear and front boards spaced several millimeters from each other, electric discharge is apt to occur between the rear and front boards.

In the conventional electron emission display, there have been made some proposals to use a special circuit for preventing electric discharge in the electron emitting section, to use an electrode for suppressing electric discharge in an invalid area and the like. Consequently, new wiring is needed, resulting in increase in the number of manufacturing steps.

In the conventional electron emission display, moreover, when electric discharge has occurred between anode and wiring, the wiring is broken and it becomes difficult to effect image display. In particular, since the scan wiring formed on the rear board is positioned closest to the anode formed on the front board, electric discharge is apt to occur between the scan wiring and the anode.

### SUMMARY OF THE INVENTION

The display device according to the present invention has a housing, the housing comprising a first board formed with electron emitting elements, a second board formed with a fluorescent screen, and a frame which connects the first board with second board.

The first board has plural scanning lines extending in a first direction and arranged in a second direction intersecting the first direction, and plural data lines extending in the second direction and arranged in the first direction, the scanning lines being disposed in an upper layer with respect to the data lines. The electron emitting elements are respectively provided with first electrodes connected electrically to the scanning lines and second electrodes connected electrically to the data lines.

The second board has a black matrix layer formed with plural apertures, phosphor layers disposed respectively in the apertures of the black matrix layer, and a thin metallic layer that covers the phosphor layers.

The scanning lines each have a bottom positioned on the first board side, an upper surface positioned on the second board side, side surfaces extending from the bottom toward the second board, and connecting surfaces for connection between the upper surface and the side surfaces, the connecting surfaces being each inclined at an angle of 15° to 75° relative to the upper surface.

The width of the bottom of each scanning line, the bottom being positioned on the first board side, is larger than that of the upper surface of the same scanning line, the upper surface being positioned on the second board side.

According to the above configuration it is possible to solve the foregoing problems involved in the conventional display devices.

According to the display device of the present invention, since slant portions are formed in the surface opposed to the anode of each wiring line, it is possible to suppress electric discharge between the wiring line and the anode. In particular, each scanning line has an upper surface opposed to the front board and connecting surfaces adjacent to the upper surface and inclined at an angle of 15° to 75° relative to the upper surface. Providing such inclined connecting surfaces in each scanning line, it is possible to suppress electric discharge between the anode and the scanning line.

### BRIEF DESCRIPTION OF THE DRAWINGS

FIG. 1 is a front view of a rear board of a display device according to an embodiment of the present invention;

FIG. 2 is a sectional view of the vicinity of an electron emitting element used in the display device;

FIG. 3 is a partial sectional view of a scanning line according to the present invention;

FIG. 4 is a partial sectional view of another scanning line according to the present invention;

FIG. 5 is a sectional view of the vicinity of an electron emitting element used in a display device according to another embodiment of the present invention;

FIG. 6 is a perspective view of a rear board;

FIG. 7 is a sectional view of a front board;

FIG. 8 is a sectional view of an electron emission display according to the present invention; and

FIG. 9 is a sectional view of wiring in the vicinity of an electron emitting element for comparison with the configuration of the present invention.

### DETAILED DESCRIPTION OF PREFERRED EMBODIMENTS

Concrete embodiments of the present invention will be described in detail hereinunder with reference to the drawings.

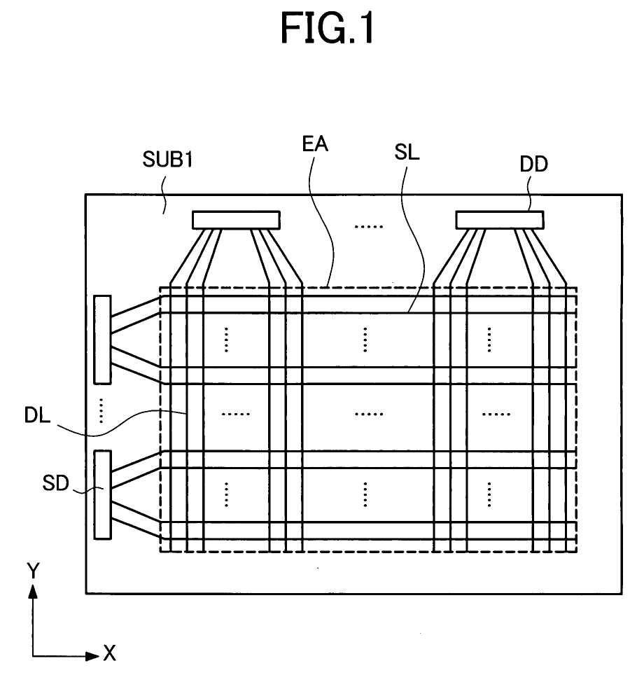

FIG. 1 is a front view of a first board as a constituent of a display device according to an embodiment of the present invention.

A first board SUB1 includes, on a main surface thereof, plural scanning lines SL extending in a first direction (X direction) and arranged side by side in a second direction (Y direction) intersecting the first direction and plural data lines DL (or cathode lines) extending in the second direction (Y direction) and arranged side by side in the first direction (X direction) intersecting the second direction. Electron emitting lines EE serving as an electron source are formed in intersecting portions of those lines or in areas surrounded with those lines. Electrodes which constitute the electron emitting elements EE are connected electrically to the scanning lines SL and data lines DL.

Plural electron emitting elements EE are present in an area including the central portion of the main surface of the first board, constituting an electron emission area EA. A peripheral area free of any electron emitting element is formed around the electron emission area EA.

The scanning lines SL are connected to a scanning line drive circuit SD, while the data lines DL are connected to a data line drive circuit DD. Both lines are supplied with data necessary for image display from the respective drive circuits.

In the display device being considered, a second board SUB2 is disposed in opposition to the first board SUB1 so as to be spaced about 3 to 5 mm from the first board. A fluorescent screen Ph is formed by a stack of phosphors on a main surface of the second board SUB2, and a peripheral area free of any phosphor layer is formed around the fluorescent screen Ph. The fluorescent screen of the second board SUB2 is disposed in opposition to the electron emission area EA of the first board SUB1.

Electrons emitted from the electron source formed on the first board SUB1 impinge on the phosphor layers formed on the second board SUB2, whereby the phosphors emit light and an image is displayed on the second board. Therefore, the first board SUB1 need not be a light transmitting board. Glass or a ceramic material, for example, is used as the material of the first board. The second board SUB2 is also called a front board because it is disposed on the front side of the image display device. Likewise, the first board SUB1 is also called a rear substrate. The rear board SUB1 and the front board SUB2 each have a generally rectangular outline, and the electron emission area EA and the fluorescent screen Ph are also each formed in a rectangular shape. Each of the rear board SUB1, the front board SUB2, the electron emission area EA and the fluorescent screen has long sides along X axis and short sides along Y axis.

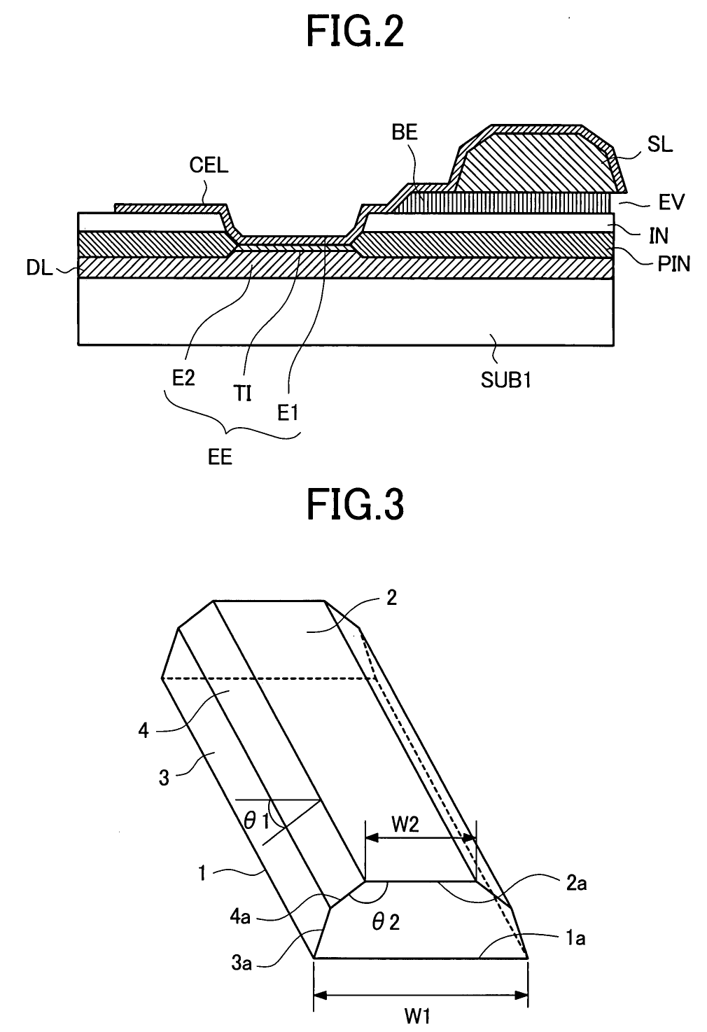

FIG. 2 is a sectional view of the vicinity of an electron emitting element. In this embodiment, an MIM (metal layer/insulator layer/metal layer) type electron source is used as each electron emitting element. a field emission type electron source, a surface conduction type electron source, or a thin film type electron source also may be used as the electron source.

The data lines DL are disposed on the rear board SUB1 which is an insulating board. Second electrodes E2 which constitute the electron emitting elements are connected to the data lines. In this embodiment, since the MIM type electron source is used, the lower electrode is connected to the data lines DL and is formed in the same layer as the data lines.

The data lines DL are formed by using Al (aluminum) or Al alloy (aluminum alloy). A protective insulating film PIN is formed over the data lines by anodic oxidation. Since Al or Al alloy is used for forming the data lines DL, a good insulating film can be formed with a high accuracy by anodic oxidation. In this embodiment, there was used Al—Nd (aluminum-neodyminum) alloy.

An interlayer insulating film IN is formed over the protective insulating film PIN to compensate for defects, e.g., pinholes, formed in the protective insulating film PIN. By forming the interlayer insulating film IN it is possible to provide positive insulation between the data lines DL and the scanning lines.

A base electrode BE is formed over the interlayer insulating film IN, and the scanning lines SL are formed over the base electrodes BE. The base electrode BE is formed of Cr for example. When patterning the base electrode BE, eaves EV are formed as shown in FIG. 2 for separation of a connecting electrode CEL.

On the other hand, a tunnel insulating film TI is formed over the second electrode E2 by anodic oxidation. A first electrode E1 as a constituent of each electron emitting element is formed over the tunnel insulating film. By virtue of a tunnel effect, electrons from the second electrode passes through the tunnel insulating film TI and reaches the first electrode. Of the electrons which have reached the first electrode, those having reached to the surface of the first electrode E1 with energy equals to or higher than the work function of the first electrode El are released into vacuum.

The connecting electrode CEL provides an electric connection between each scanning line SL and the first electrode e1 of the associated electron emitting element. The connecting electrode CEL is formed so as to cover a part of the scanning line SL.

With the base electrode, the difference in height is reduced and it is possible to prevent breaking of wire of the connecting electrode.

The scanning lines SL are disposed as an upper layer with respect to the data lines DL. Spacers are disposed over and in parallel with the scanning lines. Electric charge stored in the spacers is removed through the scanning lines.

FIG. 3 is a partial sectional view of a scanning line SL.

The scanning line SL has a bottom 1 positioned on the rear board side, an upper surface 2 positioned on the front board side, side surfaces 3 extending from the bottom 1 toward the front board, and connecting surfaces 4 for connection between the upper surface 2 and the side surfaces 3. The connecting surfaces 4 are inclined at an angle of 15° to 75° relative to the upper surface 2. On the other hand, the angle 02 between the upper surface 2 and each connecting surface 4 is in the range of 105° to 165°.

In the scanning line SL shown in FIG. 3, the side surfaces 3 are inclined. With this configuration, it is possible to suppress electric discharge which occurs between the scanning line and the anode.

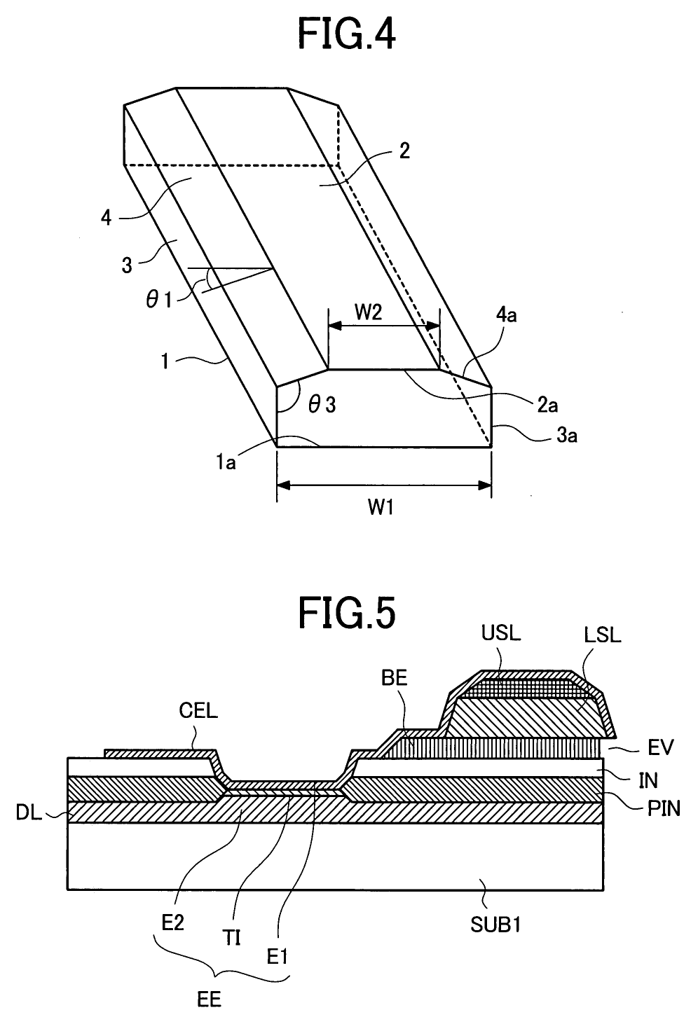

FIG. 4 is a partial sectional view of another scanning line SL, in which the same portions as in FIG. 3 are identified by the same reference numerals as in FIG. 3. The connecting surfaces 4 are inclined at an angle of 15° to 75° relative to the upper surface 2. On the other hand, the angle 02 between each side surface 3 and the associated connecting surface 4 is in the range of 105° to 165°. Insofar as the connecting surfaces 4 are inclined at an angle of 15° to 75° relative to the upper surface 2, it is not always necessary to incline the side surfaces 3 of the scanning line and the side surfaces 3 can be positioned perpendicularly to the rear board, thus permitting easy fabrication of the scanning line.

If the connecting surfaces are inclined at an angle smaller than 15° or at a large angle exceeding 75° relative to the upper surface 2, the angle between each connecting surface 4 and the upper surface 2 or the angle between each connecting surface 4 and the associated side surface 3 becomes near 90°, and hence electric discharge is more likely to occur.

In FIGS. 3 and 4, W1 stands for the width of the bottom 1 of the scanning line SL, and W2 stands for the width of the upper surface 2 of the scanning line, W2 being smaller than W1. That is, a section parallel to Y axis of the scanning line is in a trapezoidal shape wherein the base positioned on the first board side is larger than the upper side positioned on the second board side. Numeral la denotes the base of the trapezoidal section, 2a denotes the upper side of the trapezoidal section, 3a denotes a lateral edge extending from a base end of the trapezoid toward the second board, and numeral 4a denotes a connecting side for connection between the upper side la and the lateral edge 3a.

With such a configuration, it is possible to diminish edge portions which are likely to cause electric discharge and to suppress the electric discharge.

Since a spacer is disposed over the scanning line, the upper surface width W2 must be made larger than the spacer width. Since the spacer width is about 100 μm, it is necessary that the upper surface width W2 be larger than 100 μm. Moreover, for forming a high definition image, an appropriate value of the bottom width W1 is 400 μm or less.

Although the scanning line width differs depending on the size and resolution of the image display device, it is preferable that the scanning line width be as large as possible in order to make the resistance low. A suitable scanning line width is half of or more than the scanning line pitch, i.e., about 300 to 400 μm.

FIG. 5 is a sectional view of the vicinity of an electron emitting element, showing another embodiment of the present invention, in which the same portions as in the previous embodiment are identified by the same reference numerals as in the previous embodiment.

Each scanning line SL used in this embodiment is made up of two layers: a lower scanning line LSL located on a rear board SUB1 side; and an upper scanning line USL located on a front board side. Since such two wiring layers are used, it is possible to control the wiring resistance and corrosion resistance (corrosiveness).

Side surfaces which connect an upper surface of the lower scanning line LSL with a bottom are inclined at 90° or less relative to the rear board.

The upper scanning line USL formed over the lower scanning line LSL have side surfaces which connect an upper surface of the upper scanning line with a bottom, the side surfaces being inclined at an angle of 75° or less relative to the rear board.

These slant surfaces extend continuously in the extending directions of the wiring lines.

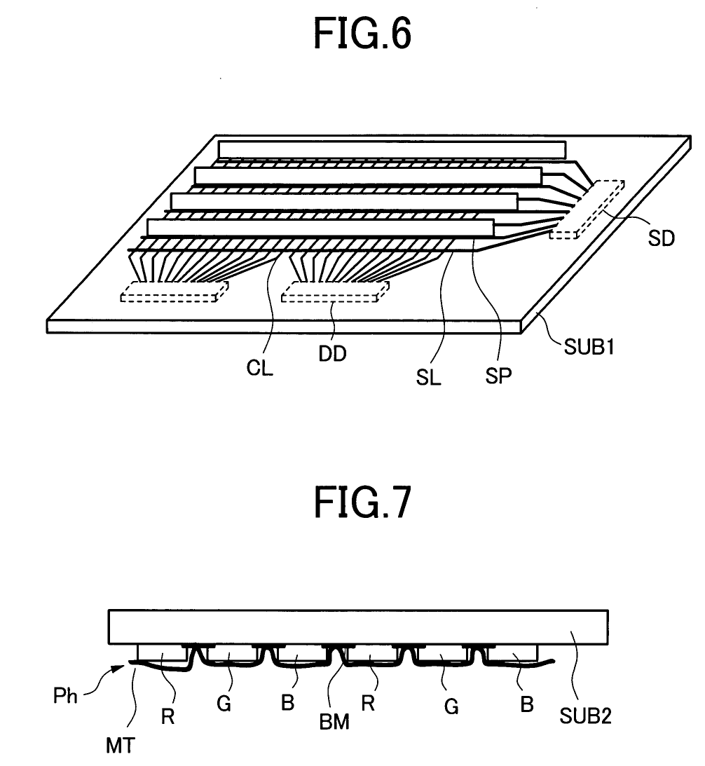

FIG. 6 is a perspective view showing a positional relation between the rear board and spacers. Spacers SP are disposed over scanning lines. In FIG. 6, the spacers are disposed every other scanning line LS, but may be disposed every several scanning lines or every each scanning line.

FIG. 7 is a sectional view of a front board SUB2. The front board SUB2 has one surface formed as a fluorescent screen. The fluorescent screen has a black matrix BM, phosphor layers and a metal back MT. The black matrix layer has plural apertures. The phosphor layers are disposed in the apertures of the black matrix BM so as to cover a part of the black matrix BM. The phosphor layers are composed of red phosphor layers R, blue phosphor layers B and green phosphor layers G. A reflection film is disposed so as to cover the black matrix layer and the phosphor layers.

The metal back MT is a thin metallic film and is formed by vapor deposition of aluminum. The metal back MT functions to reflect light emitted from the phosphors to the outside of the front board. An anode voltage of about 7 to 10 kV is applied to the metal back MT, whereby the metal back also functions as an anode. An observer can observe the emission of light on the fluorescent screen Ph through the front board SUB2.

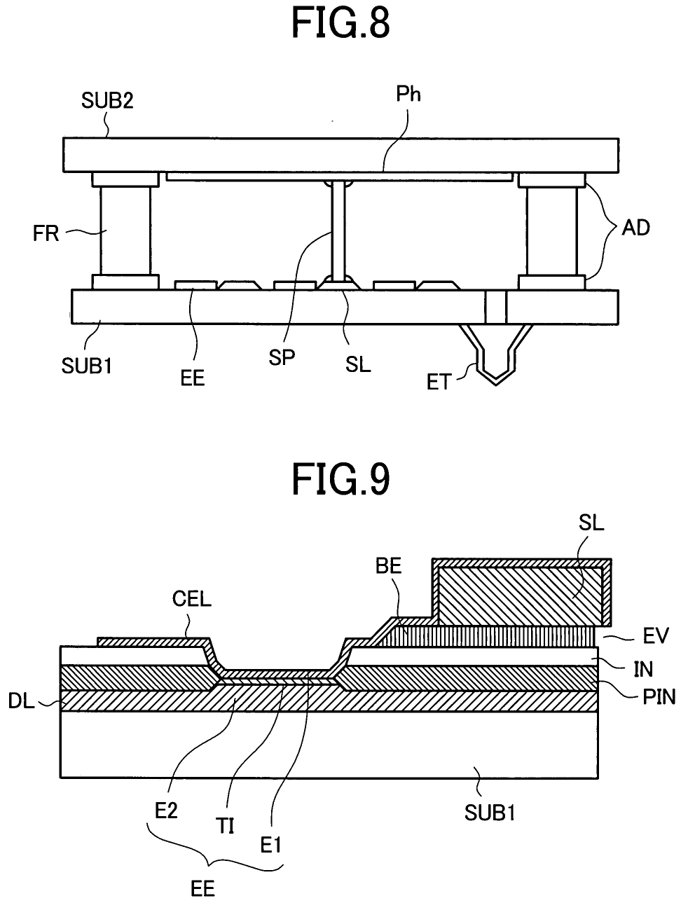

FIG. 8 is a sectional view of an electron emission display according to the present invention. In this display device, a housing (or a vessel) is composed of a rear board SUB1 having a plurality of electron emitting elements, a front board SUB2 having a fluorescent screen, and a frame FR which connects between the rear board and the front board. The rear board SUB1 and the frame FR, as well as the front board SUB2 and the frame FR, are respectively fixed by fusion bonding of frit glass AD.

The interior of the housing is held in vacuum of a high degree in order to facilitate movement of electrons emitted from electron emitting elements. Gas present in the interior of the housing is discharged from an exhaust pipe ET through an exhaust port formed in the rear board. Thereafter, the exhaust pipe is chipped off and sealed.

The electrons emitted from the electron emitting elements impinge on the fluorescent screen disposed in opposition to the electron emitting elements, whereby the fluorescent screen emits light and an image is displayed. The housing is designed so as to withstand the atmospheric pressure, but in the case where the screen size of the display device is large, there is the possibility that the front board or the rear board may be depressed inwards of the housing. Therefore, spacers are disposed within the image display area to suppress the depression of the front board and the rear board.

Using an electrically conductive adhesive, the spacers SP are fixed to the scanning lines on the rear board. The spacers are disposed over the scanning line SL. It is preferable that the width of each spacer SP be narrower than the width of the upper surface of each scanning line SL. If the spacer width is 100 to 200 μm, even a Model 32 display device can maintain a high resolution. In this case, the upper surface with W2 of the scanning line is 100 to 200 μm or more, while, as noted above, the scanning line width, i.e., the lower surface width W1 of the scanning line is 300 to 400 μm. It follows that the upper surface width W2 is smaller by about 100 to 300 μm than the lower surface width W1.

FIG. 9 is a sectional view of the vicinity of an electron emitting element for comparison with the configuration of the present invention. The portions having the same functions as in the above embodiments in driving the display device are identified by the same reference numerals as in the above embodiments. A scanning line SL shown in FIG. 9 has a generally rectangular sectional shape. Therefore, it has substantially right-angled corner portions on the front board side. The corner portions of the scanning line can be a cause of electric discharge between them and the anode formed on the front board.

On the other hand, when the section of each scanning line in the configuration of each of the above embodiments is observed, the scanning line has an inclined portion on each surface thereof opposed to the anode. That is, each corner portion of the scanning line opposed to the anode is formed at an angle exceeding 90° It is possible, therefore, to suppress electric discharge between the scanning line and the anode.

What is claimed is:

1. A display device having a housing, said housing comprising a first board formed with electron emitting elements, a second board formed with a fluorescent screen, and a frame fixed to both said first board and said second board, the interior of said housing being evacuated, wherein:
said first board having a plurality of scanning lines extending in a first direction and arranged in a second direction intersecting said first direction and a plurality of data lines extending in said second direction and arranged in said first direction, said scanning lines being disposed in an upper layer with respect to said data lines, said scanning lines each having a bottom positioned on the first board side, an upper surface positioned on the second board side, side surfaces extending from said bottom toward said second board, and connecting surfaces for connection between said upper surface and said side surfaces, said connecting surfaces being each inclined at an angle of 15° to 75° relative to said upper surface, and said electron emitting elements being respectively provided with first electrodes connected electrically to said scanning lines and second electrodes connected electrically to said data lines; and
said second board having a black matrix layer formed with a plurality of apertures, phosphor layers disposed respectively in said apertures of said black matrix layer, and a thin metallic layer that covers said phosphor layers.

2. The display device according to claim 1, wherein the angle between each of said side surfaces and said bottom is in the range of 15° to 75°.

3. A display device having a housing, said housing comprising a first board formed with electron emitting elements, a second board formed with a fluorescent screen, and a frame fixed to both said first board and said second board, the interior of said housing being evacuated, wherein:
said first board having a plurality of scanning lines extending in a first direction and arranged in a second direction intersecting said first direction and a plurality of data lines extending in said second direction and arranged in said first direction, said scanning lines being disposed in an upper layer with respect to said data lines, said scanning lines each comprising an upper scanning line and a lower scanning line, said upper and lower scanning lines being formed of different materials, a section of each of said upper scanning line having an upper side and lateral edges, the angle between said upper side and each of said lateral edges being in the range of 15 to 75 degrees, and said electron emitting elements being respectively provided with first electrodes connected electrically to said scanning lines and second electrodes connected electrically to said data lines; and
said second board having a black matrix layer formed with a plurality of apertures, phosphor layers disposed respectively in said apertures of said black matrix layer, and a thin metallic layer that covers said phosphor layers.

4. The display device according to claim 3, wherein a section of said lower scanning line has an upper side and lateral edges, the angle between said upper side and said lateral edges of the lower scanning line being in the range of 15 to 75 degrees.

5. The display device according to claim 3, wherein the upper side of said lower scanning line and a bottom of said upper scanning line are coincident with each other.

6. A display device having a housing, said housing comprising a first board formed with electron emitting elements, a second board formed with a fluorescent screen, and a frame fixed to both said first board and said second board, the interior of said housing being evacuated, wherein:
said first board having a plurality of scanning lines extending in a first direction and arranged in a second direction intersecting said first direction and a plurality of data lines extending in said second direction and arranged in said first direction, said scanning lines being disposed in an upper layer with respect to said data lines, said scanning lines each having a bottom positioned on the first board side and an upper surface positioned on the second board side, the width of said bottom being larger than that of said upper surface, and said electron emitting elements being respectively provided with first electrodes connected electrically to said scanning lines and second electrodes connected electrically to said data lines; and
said second board having a black matrix layer formed with a plurality of apertures, phosphor layers disposed respectively in said apertures of said black matrix layer, and a thin metallic layer that covers said phosphor layers.

7. The display device according to claim 6, wherein the width of said bottom is larger by 100 μm or more than that of said upper surface.

8. The display device according to claim 6, wherein the difference between the width of said bottom and the width of said upper surface is in the range of 100 to 300 μm.

9. The display device according to claim 6, wherein the width of said upper surface is 100 μm or more.

10. The display device according to claim 6, wherein the width of said bottom is 400 μm or less.

11. The display device according to claim 6, wherein said scanning lines each comprise an upper scanning line and a lower scanning line, said upper and lower scanning lines being formed of different materials, an upper surface of said upper scanning line having a width of 100 μm or more and a bottom of said lower scanning line having a width of 400 μm or less.
